(19) United States
(12) Patent Application Publication
(10) Pub. No.: US 2026/0338331 A1
(43) Pub. Date: Oct. 29, 2026

(54) ULTRAVIOLET A LIGHT EMITTING DIODE LAMP COMPATIBLE WITH ELECTROMAGNETIC BALLAST AND ALTERNATING CURRENT INPUT

(71) Applicant: REALM TECHNOLOGY CO., LTD., KAOHSIUNG CITY (TW)

(72) Inventor: YEH-CHIN LIN, KAOHSIUNG CITY (TW)

(21) Appl. No.: 19/186,925

(22) Filed: Apr. 23, 2025

(51) Int. Cl. F21K 9/27; A01M 1/04; A01M 1/22; F21Y 103/10; F21Y 115/10

(52) U.S. Cl. CPC F21K 9/27; A01M 1/04; A01M 1/223; F21Y 2103/10; F21Y 2115/10

(57) ABSTRACT

An ultraviolet A (UVA) light emitting diode (LED) lamp compatible with an electromagnetic ballast and an alternating current (AC) input is provided. The UVA LED lamp uses UVA LEDs as light sources and includes a lamp casing, a LED substrate, and lamp plugs. A positioning portion is disposed on an inner wall of the lamp casing and the LED substrate is mounted into the positioning portion. The lamp plugs are arranged at two ends of the lamp casing correspondingly and at least one of the lamp plugs is electrically connected to the LED substrate. The UVA LED lamp is applied to a bug zapper and compatible with a fluorescent UVA lamp. By features of LED including high efficiency, long service life, and low energy consumption, the UVA LED lamp provides higher luminous efficiency (lm/W). During insect catching, energy saving, environmental protection, and high luminous efficiency are all achieved.

### BACKGROUND OF THE INVENTION

### FIELD OF THE INVENTION

The present invention relates to an ultraviolet A (UVA) light emitting diode (LED) lamp compatible with an electromagnetic ballast and an alternating current (AC) input, especially to a UVA LED lamp not only compatible with an electromagnetic ballast and an alternating current (AC) input, but also having advantages of power saving, environmental protection, and high efficiency.

### DESCRIPTION OF RELATED ART

Generally, a conventional bug zapper is provided with a light, a high-voltage grid, and a mesh casing. The bug zapper attracts and kills insects due to nocturnality, phototaxis, and attraction to carbon dioxide of the insects. The insects are attracted to the high-voltage electrical grid by the light and electrocuted instantly on contact with the high-voltage grid. Or the insects are drawn into an insect trap on the bottom of the bug zapper, get stuck and dehydrated to death.

The bug zapper usually uses violet lights which emit ultraviolet A (UVA) rays with wavelengths from 355 nm to 370 nm. The light of the bug zapper with a power greater than 8 Watt is more effective to attract the insects. The UVA lights have been widely used in many fields including scientific research, medical devices, sterilization and disinfection. However, conventional UVA gas-discharge lamps have certain shortcomings such as waste of energy, contamination (due to hazardous substances such as mercury), and low efficiency.

### SUMMARY OF THE INVENTION

Therefore, it is a primary object of the present invention to provide an ultraviolet A (UVA) light emitting diode (LED) compatible with an electromagnetic ballast and an alternating current (AC) input, especially to a replaceable UVA LED with advantages of power-saving, environmental protection, and high efficiency.

In order to achieve the above objects, a UVA LED lamp according to the present invention is using UVA LEDs as light sources and composed of a lamp casing, a LED substrate, and lamp plugs. A positioning portion is arranged at an inner wall of the lamp casing and the LED substrate is mounted into the positioning portion. The lamp plugs are disposed on two ends of the lamp casing correspondingly. At least one of the lamp plugs is electrically connected to the LED substrate. Thereby the UVA LED lamp is applied to a bug zapper and able to replace a conventional fluorescent UVA lamp with the electromagnetic ballast and the alternating current (AC) input. By the UVA LED lamp that attracts and kills insects and features of LED including high efficiency, long service life, and low energy consumption, the UVA LED lamp provides higher luminous efficiency (lm/W). During insect catching, energy saving, environmental protection, and high luminous efficiency are all achieved.

Preferably, the bug zapper includes a main body and a plurality of insect trap units arranged in the main body.

Preferably, the insect trap unit can be a high voltage electrical grid by which insects are killed instantly upon contact.

Preferably, the insect trap unit can also be a suction fan which draws insects into an insect collecting net on a bottom of the device. Then the insects are ensnared and air-dried to death in the insect collecting net.

### BRIEF DESCRIPTION OF THE DRAWINGS

FIG. 1 is an exploded view of an embodiment of a UVA LED lamp according to the present invention;

FIG. 2 is a perspective view of an embodiment of a UVA LED lamp according to the present invention;

FIG. 3 is a cross sectional view of an embodiment of a UVA LED lamp according to the present invention; and

FIG. 4 is a schematic drawing showing an embodiment of a UVA LED lamp installed at a bug zapper according to the present invention.

### DETAILED DESCRIPTION OF THE PREFERRED EMBODIMENT

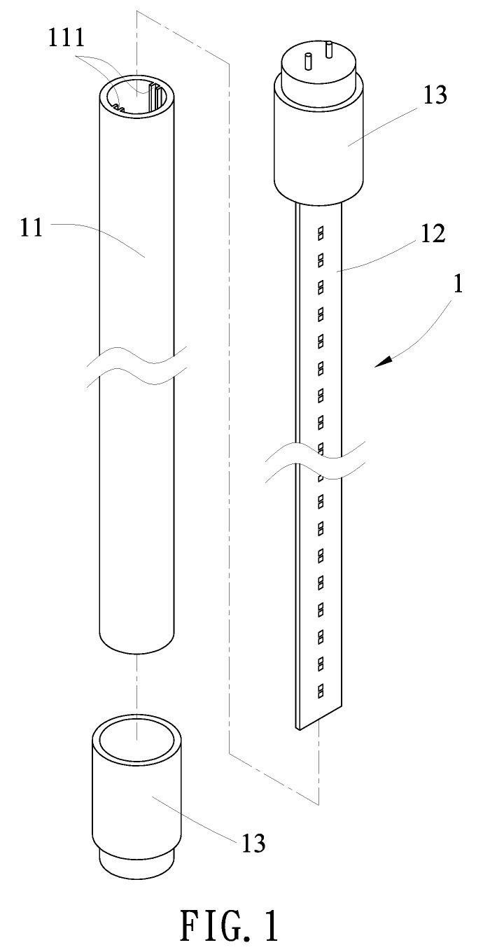

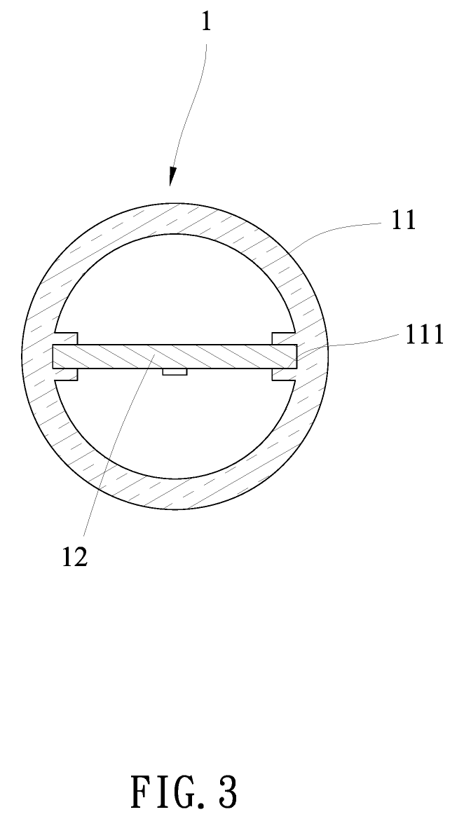

Referring to FIG. 1-3, an exploded view, a perspective view, and a sectional view of an ultraviolet A (UVA) light emitting diode (LED) lamp 1 compatible with an electromagnetic ballast and an alternating current (AC) input according to the present invention are provided. The UVA LED lamp 1 uses LEDs with wavelengths of UVA as light sources.

The UVA LED lamp 1 consists of a lamp casing 11 with a positioning portion 111 arranged at an inner wall of the lamp casing 11, a LED substrate 12 mounted into the positioning portion 111, and a lamp plug 13 disposed on each of two ends of the lamp casing 11. At least one of the lamp plugs 13 is electrically connected to the LED substrate 12.

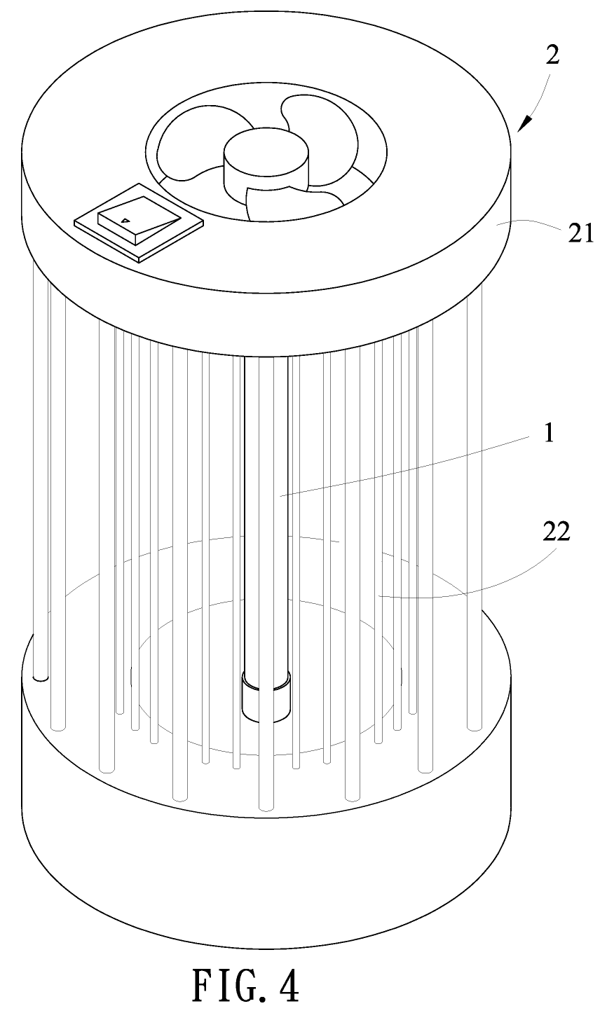

Refer to FIG. 4, it shows the UVA LED lamp 1 is mounted to a bug zapper 2 which is further provided with a main body 21 and a plurality of insect trap units 22 arranged in the main body 21.

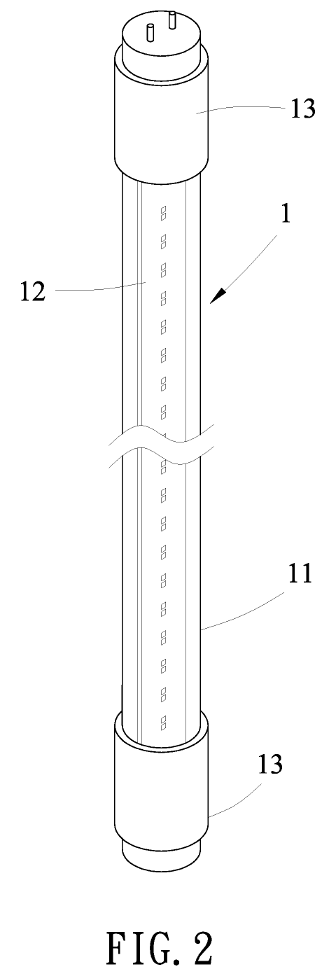

While being assembled, referring to FIG. 2 to FIG. 4, the LED substrate 12 is mounted into the positioning portion 111 inside the lamp casing 11. Then the lamp plugs 13 are disposed on the two ends of the lamp casing 11 correspondingly to complete the assembly of the UVA LED lamp 1. Next the UVA LED lamp 1 is mounted to the main body 21. After users turn on a power source, the UVA LED lamp 1 attracts flying insects and then insect trap units 22 draw and eliminate them. The insect trap unit 22 can be a high voltage electrical grid by which the insects are killed instantly upon contact. The insect trap unit 22 can also be a suction fan which draws insects into an insect collecting net on a bottom of the device. Then the insects are ensnared and air-dried to death in the insect collecting net.

It should be noted that the UVA LED lamp 1 can be detached and replaced directly. Even the bug zapper 2 uses a conventional gas discharge lamp or a fluorescent UVA lamp together with the electromagnetic ballast and the alternating current (AC) input, the fluorescent UVA lamp or the gas discharge lamp can be removed and replaced by the present UVA LED lamp 1. The UVA LED lamp 1 attracts insects while the insect trap unit 22 catches and kills the insects. By features of the LED including high performance, long service life, and low energy consumption, the UVA LED lamp 1 provides higher luminous efficiency (lm/W). During insect catching, energy saving, environmental protection, and high luminous efficiency are all achieved.

The present UVA LED lamp 1 has the following advantages.
1. The power consumption of the present UVA LED tubular lamp compatible with the electromagnetic ballast and the AC input is lower than the conventional tubular light so that efficient-saving of larger amount of power, energy conservation, and carbon reduction can be achieved.
2. The present UVA LED lamp compatible with the electromagnetic ballast and the AC input includes no hazardous substances such as mercury (mercury free). Thereby a potential risk to human health and the environment posed by the hazardous substance can be avoided completely.
3. The present UVA LED lamp compatible with the electromagnetic ballast and the AC input has fast activation speed and no warm up time is required. Best lighting effect is achieved within a wide range of operating temperature.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An ultraviolet A (UVA) light emitting diode (LED) lamp compatible with an electromagnetic ballast and an alternating current (AC) input, and using LED emitting UVA light as a light source comprising a lamp casing with a positioning portion arranged at an inner wall of the lamp casing, a LED substrate mounted into the positioning portion, and a lamp plug disposed on each of two ends of the lamp casing; at least one of the lamp plugs is electrically connected to the LED substrate.

2. The UVA LED lamp compatible with an electromagnetic ballast and an alternating current (AC) input as claimed in claim 1, wherein the UVA LED lamp is disposed in a bug zapper in a replaceable manner.
